(19) United States
(12) Patent Application Publication
(10) Pub. No.: US 2009/0090401 A1
(43) Pub. Date: Apr. 9, 2009

(54) Appliance with Multiple Source Wash Aid Pump

(75) Inventor: Mark S. Feddema, Kalamazoo, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, Benton Harbor, MI (US)

(21) Appl. No.: 11/867,754

(22) Filed: Oct. 5, 2007

(51) Int. Cl. B08B 3/04

(52) U.S. Cl. 134/184

(57) ABSTRACT

An appliance for washing articles such as clothing or utensils, comprises a wash chamber, a wash aid dispensing pump fluidly connected to the wash chamber, multiple wash aid reservoirs and at least one wash aid coupler to fluidly couple the multiple wash aid reservoirs and wash aid dispensing pump. Wherein the wash aid coupler acts as a valve to selectively dispense the wash aid in at least one of the wash aid reservoirs to the wash aid dispensing pump to achieve a more complex cycle of the appliance.

### BACKGROUND OF THE INVENTION

Contemporary cleaning appliances, such as dishwashers or clothes washers, use increasingly complex wash cycles to achieve better cleaning and/or more efficient use of resources such as: electricity, water, and wash aids. The complex wash cycles may take into account the type and quantity of the items being cleaned along with the type and quantity of soils and stains on the items in selecting the steps of a wash cycle along with the corresponding time, temperature, liquid volume, and the type and quantity of wash aids, e.g. detergents, bleach, enzymes, anti-spotting agents, aroma agents, etc. A problem currently encountered by contemporary cleaning appliances is the ability to selectively meter the desired type and amount of wash aid at the appropriate time in the wash cycle.

### SUMMARY OF THE INVENTION

The invention provides for the selective dispensing of multiple wash aids by providing an appliance having a wash chamber for receiving articles for washing, and comprising a dispensing pump having an outlet fluidly coupled to the wash chamber, multiple wash aid reservoirs, and at least one wash aid coupler selectively fluidly coupling the wash aid reservoirs to the wash aid dispensing pump.

### BRIEF DESCRIPTION OF THE DRAWINGS

In the drawings:

FIG. 1 is a schematic view of a dishwasher according to the invention with wash chamber, upper and lower racks, and multiple source detergent pump.

FIG. 2 is a second embodiment of the multiple source detergent pump of the dishwasher of FIG. 1 with a valve assembly.

FIG. 3 is an enlarged view of one position of the valve assembly of FIG. 2.

FIG. 4 is an enlarged view of a second position of the valve assembly of FIG. 2.

FIG. 5 is an enlarged view of a third position of the valve assembly of FIG. 2.

FIG. 6 is a third embodiment of the multiple source wash aid pump.

### DESCRIPTION OF EMBODIMENTS OF THE INVENTION

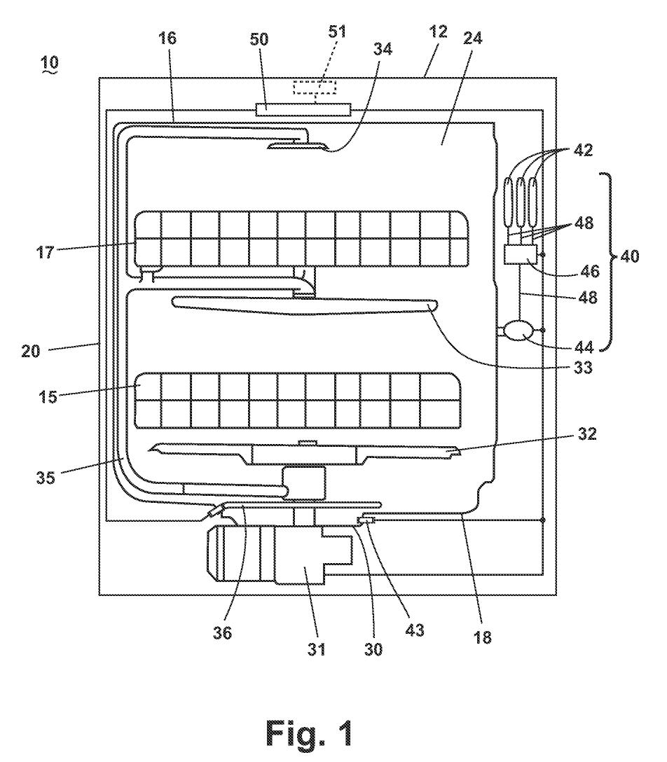

Referring now to FIG. 1 an embodiment of the invention is illustrated comprising an automated dishwasher 10 having a housing 12. Although much of the remainder of this application will focus on the embodiment of a dishwasher, the invention has utility in other environments, including other appliances, such as clothes washers. The dishwasher 10 shares many features of a conventional automated dishwasher, which will not be described in detail herein except as necessary for a complete understanding of the invention.

The housing 12 has spaced top and bottom walls 16 and 18, and spaced side walls 20. The walls 16, 18, and 20 join along their respective edges to define the wash chamber 24. As one of skill in the art will appreciate, the front wall may be the door of the dishwasher 10, which may be pivotally attached to the dishwasher 10 for providing accessibility to the wash chamber 24 for loading and unloading utensils or other washable items. While the present invention is described in terms of a conventional dishwashing unit as illustrated in FIG. 1, it could also be implemented in other types of dishwashing units such as in-sink dishwashers or drawer dishwashers.

Utensil holders in the form of upper and lower racks 15, 17 are located within the wash chamber 24 and receive utensils for washing. The upper and lower racks 15, 17 are typically mounted for slidable movement in and out of the wash chamber 24 for ease of loading and unloading. As used in this description, the term utensil is generic to dishes and the like that are washed in the dishwasher 10 and expressly includes, dishes, plates, bowls, silverware, glassware, stemware, pots, pans, and the like.

The bottom wall 18 of the dishwasher may be sloped to define a lower tub region or sump 30 of the tub. A pump assembly 31 may be located in or around a portion of the bottom wall 18 and in fluid communication with the sump 30 to draw wash liquid from the sump 30 and to pump the liquid to at least a lower spray arm assembly 32. If the dishwasher has a mid-level spray arm assembly 33 and/or an upper spray arm assembly 34, liquid may be selectively pumped through a supply tube 35 to each of the assemblies for selective washing.

In this embodiment, the lower spray arm assembly 32 is positioned beneath a lower utensil rack 15, the mid-level spray arm assembly 33 is positioned between an upper utensil rack 17 and the lower utensil rack 15, and the upper spray arm assembly 34 is positioned above the upper utensil rack 17. The lower spray arm assembly is configured to rotate in the tub and spray a flow of wash liquid, in a generally upward direction, over a portion of the interior of the tub. The spray from the lower spray arm is typically directed to wash utensils located in the lower rack. Like the lower spray arm assembly, the mid-spray arm assembly may also be configured to rotate in the dishwasher 10 and spray a flow of wash liquid, in a generally upward direction, over a portion of the interior of the tub. In this case, the spray from the mid-spray arm assembly is directed to utensils in the upper utensil rack. Typically, the upper spray assembly 34 generally directs a spray of wash water in a generally downward direction and helps wash utensils on both utensil racks.

The pump assembly 31, spray arm assemblies 32-34 and supply tube 35 collectively form a liquid recirculation system for spray liquid within the wash chamber 24. The pump draws liquid from the sump 30 and delivers it to one or more of the spray arm assemblies 32-34 through the supply tube 35, where the liquid is sprayed back into the wash chamber 24 through the spray arm assemblies 32-34 and drains back to the sump 30 where the process is repeated. While the spray arm assemblies 32 and 33 are illustrated as rotating spray arms and spray arm assembly 34 is illustrated as a fixed spray head, the spray arm assemblies can be of any structure and configuration.

A heater 36 is located within the sump for heating the water contained in the sump. A controller 50 is operably coupled to the sump and heater and controls the operation of the sump and heater to implement the selected cycle. The controller 50 may comprise a user interface enabling the user to select the desired wash cycle and set correspondingly relevant parameters or options for the cycle. A control panel 51, shown in phantom, may be coupled to the controller 50 and may provide for input/output to/from the controller 50. The control panel may be any suitable input/output device, such as a touch panel, switches, knobs, displays, indicators, etc., and any combination thereof.

The controller may also be coupled to an appliance sensor 43. A single sensor or multiple sensors may be coupled with the controller. Sensors typically include those for temperature, soil, and turbidity. The controller 50 may select the dishwashing cycle and control wash aid dispensing in response to feedback from the appliance sensors 43 in the appliance. The controller 50 may receive data from one or more of the appliance sensors 43 and may provide commands, which may be based on the received data, to one or more of the working components to execute a desired operation of the dishwasher 10. Many known types of controllers may be used for the controller 50. The specific type of controller is not germane to the invention. The controller 50 may also be coupled to a valve assembly (not shown) to selectively supply liquid to the spray arm assemblies 32-34.

In this embodiment, a multiple wash aid supply system 40 is located inside the housing 12 of the dishwasher 10. The multiple wash aid supply systems 40 comprises multiple wash aid reservoirs 42, a wash aid dispensing pump 44, and at least one wash aid coupler 46. The multiple wash aid reservoirs 42 are fluidly coupled to the wash aid dispensing pump 44 by the wash aid coupler 46 through conduits 48. The wash aid coupler 46 fluidly couples the multiple wash aid reservoirs 42 to the wash aid dispensing pump 44 such that a wash aid in the reservoir may be dispensed by the wash aid dispensing pump 44 into the wash chamber 24.

It is contemplated that each of the wash aid reservoirs will contain a bulk supply, i.e. multiple charges, of a different wash aid. A bulk wash aid is a solid, powder or liquid of multiple charges of a wash aid for use in multiple dishwashing cycles. When this form of wash aid is employed, the user does not have to replace it between each use of the dishwasher nor determine the quantity of wash aid in the dishwasher liquid solution. A benefit of a bulk wash aid is that the multiple wash aid supply system 40 may be used to meter the amount of wash aid supplied to the solution. That is, the amount of wash aid dispensed from the corresponding multiple wash aid reservoirs 42 may be varied by the appliance as needed depending on the selected cycle and the conditions during the wash cycle, such as degree of soiling, type of soiling, water temperature, etc.

It is within the scope of the invention for the wash reservoirs to hold a single charge that must be filled as part of each wash cycle. It is also within the scope of the invention for more than one of the multiple wash aid reservoirs 42 to contain the same wash aid, especially if the multiple wash aid reservoirs 42 contain only a single charge instead of a bulk supply. The multiple wash aid reservoirs 42 may be any suitable shape and size and connect to the wash aid coupler 46 in any suitable manner. In either case, especially in the case of a bulk supply container, the multiple wash aid reservoirs 42 may be replaceably mounted to the coupler for each of replacement when one of the multiple wash aid reservoirs 42 is empty. One illustrative example is a cartridge that may be replaced after one or multiple uses. Another illustrative example is a container with an opening through which the wash aid may be refilled after one or multiple uses. The multiple wash aid reservoirs 42 may be located anywhere within the housing 12 of the dishwasher 10 or may even be mounted on the inside surface of the door such that the multiple wash aid reservoirs 42 are disposed in the wash chamber 24 when the door is closed. Most practically, the multiple wash aid reservoirs 42 will be placed where the user may easily refill them or replace them.

The type of wash aid contained in each of the multiple wash aid reservoirs 42 is not germane to the invention. Examples of common wash aids include: a detergent, a drying agent, a spot reducer, a rinse agent, a stain remover, bleach, or any other similar product that facilitates excellent cleaning of the utensils.

The wash aid coupler 46 selectively fluidly couples the multiple wash aid reservoirs 42 to the wash aid dispensing pump 44. The multiple wash aid reservoirs 42 are fluidly connected to the wash aid dispensing pump 44 through a series of conduits 48. The wash aid coupler 46 is able to dispense a variable amount of at least one of the wash aids from the multiple wash aid reservoirs 42 depending on the dishwashing cycle selected by the user or based upon feedback from the appliance sensors 43, such as temperature, soil, and turbidity. The wash aid coupler 46 may dispense variable amounts of wash aid in multiple charges of a predetermined amount, and the multiple charges may be dispensed at different times throughout the dishwashing cycle.

During operation of the dishwasher 10, the multiple wash aid supply system 40 may be employed to dispense the wash aids contained therein into the wash chamber 24 under the control of the controller 50. When time comes to dispense the wash aid, the controller 50 signals the wash aid coupler 46 and the wash aid dispensing pump 44 to supply a wash aid from at least one of the multiple wash aid reservoirs 42 to the wash chamber 24 through the wash aid dispensing pump 44 and any accompanying sprayers or conduits. The controller 50 sends a signal to the wash aid coupler 46 to selectively or incrementally control the discharging of the desired wash aid by fluidly coupling the corresponding reservoir to the wash aid dispensing pump 44 and then activating the wash aid dispensing pump 44 to dispense the wash aid from the multiple wash aid reservoirs 42 to the wash chamber 24.

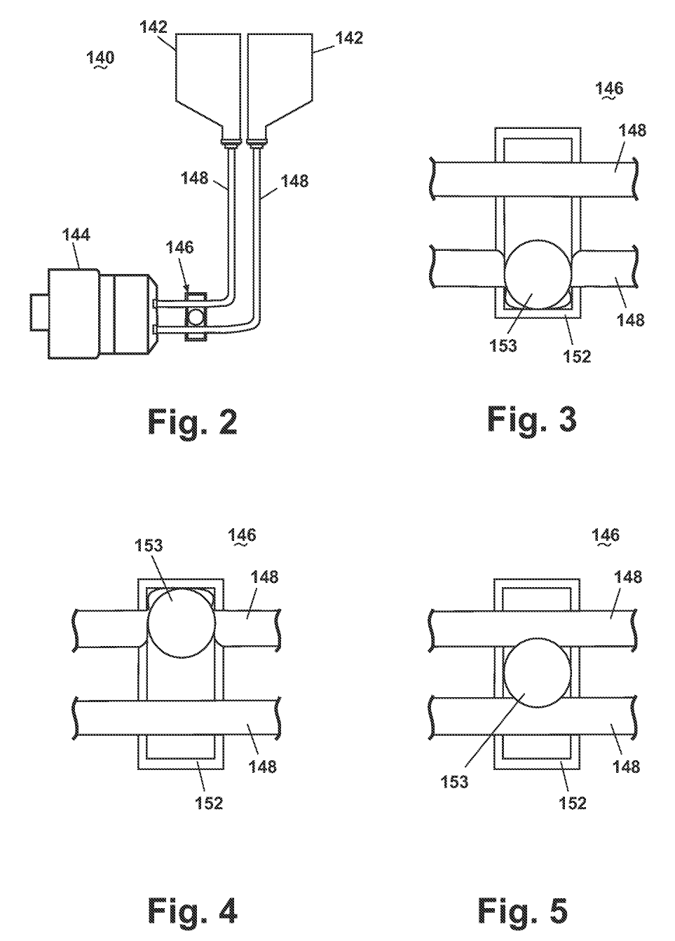

FIG. 2 is a second embodiment of the invention and comprises a wash aid supply system 140. The multiple wash aid supply system 140 comprises multiple wash aid reservoirs 142, a wash aid dispensing pump 144, and at least one wash aid coupler 146. The multiple wash aid reservoirs 142 are fluidly coupled to the wash aid dispensing pump 144 by the wash aid coupler 146 through conduits 148. The wash aid coupler 146 fluidly couples the multiple wash aid reservoirs 142 to the wash aid dispensing pump 144 by way of a valve assembly 152 such that a wash aid in the reservoir may be dispensed by the wash aid dispensing pump 144 into the wash chamber 24.

In this embodiment of the wash aid coupler 146, the valve assembly 152 is that of a bar 153 controlled by a solenoid actuator (not shown). The valve assembly 152, shown schematically in FIGS. 3-4, controls, i.e. turns on and off, the dispensing of liquid through the conduits 48 by moving a bar 153 to pinch at least one of the conduits 48 closed.

In this manner, the wash aid coupler 146 selectively fluidly couples the multiple wash aid reservoirs 142 to the wash aid dispensing pump 144. During operation of the dishwasher 10, the multiple wash aid supply system 140 may be employed to dispense the wash aids contained therein into the wash chamber 24 under the control of the controller 50. When time comes to dispense the wash aid, the controller 50 signals the solenoid actuator, which in turns moves the bar 153 in the valve assembly 152, and the wash aid dispensing pump 144 to supply a wash aid from at least one of the multiple wash aid reservoirs 142 to the wash chamber 24 through the wash aid dispensing pump 144 and any accompanying sprayers or conduits.

In the embodiment shown in FIGS. 2-5, the wash aid coupler 146 acts as a valve and meters the fluid communication between the multiple wash aid reservoirs 142 that house the liquid wash aids and the wash aid dispensing pump 144. In FIG. 5 the moveable bar 153 of the valve assembly 152 is moved so that it may only partially close of either of the conduits 148 and thus acts as a mixing valve as opposed to the full on/off valve as shown in FIGS. 3-4. This may be done in any increment to dispense any ratio of multiple wash aids that may be desired. The controller 50 may send a signal to the valve assembly 152 to selectively or incrementally control the discharging of the desired ratio of wash aid by fluidly coupling the corresponding reservoir to the wash aid dispensing pump 144 and then activating the wash aid dispensing pump 144 to dispense the wash aid from the multiple wash aid reservoirs 142 to the wash chamber 24.

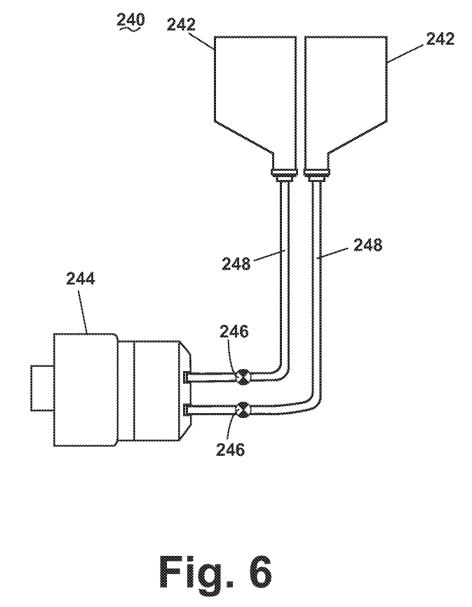

The wash aid supply system may differ from the configuration shown in FIGS. 1-5, such as by inclusion of other valves, conduits, agent reservoirs, and the like, to control the flow of liquid through the dishwasher 10 and for the introduction of one or more wash aids. For example, FIG. 6 is a third embodiment of the invention wherein the wash aid supply system 240 comprises multiple wash aid reservoirs 242, a wash aid dispensing pump 244, and a wash aid coupler. The multiple wash aid reservoirs 242 are fluidly coupled to the wash aid dispensing pump 244 by the wash aid coupler through conduits 248. In this embodiment, multiple valves 246 make up the valve assembly that forms the wash aid coupler. These multiple valves 246 may be any type of valve including a solenoid-type valve. Such valves are well known in the field and are not germane to this invention. The valves 246 for each conduit 248 collectively form the wash aid coupler for the wash aid supply system 240 and may individually controlled by the controller 50 or controlled in combination by the controller 50. The wash aid coupler fluidly couples the multiple wash aid reservoirs 242 to the wash aid dispensing pump 244 such that a wash aid in the reservoir may be dispensed by the wash aid dispensing pump 244 into the wash chamber 24.

In another embodiment, the invention relates to any washing appliance including a clothes washer comprising a wash chamber, a dispensing pump having an outlet fluidly coupled to the wash chamber, multiple wash aid reservoirs, and at least one wash aid coupler selectively fluidly coupling the wash aid reservoirs to the dispensing pump. The at least one wash aid coupler may selectively determine which wash aids to dispense and when, and in what amount those wash aids are to be dispensed based upon user selection or feedback from sensors in the clothes washing machine. In this embodiment the wash aid may be any aid for treating fabric, and examples of aids may include, but are not limited to washing aids, such as detergents and oxidizers, including bleaches, and additives, such as fabric softeners, sanitizers, de-wrinklers, and chemicals for imparting desired properties to the fabric, including stain resistance, fragrance (e.g., perfumes), insect repellency, and UV protection.

While the invention has been specifically described in connection with certain specific embodiments thereof, it is to be understood that this is by way of illustration and not of limitation, and the scope of the appended claims should be construed as broadly as the prior art will permit.

What is claimed is:

1. An appliance comprising:
a wash chamber;
a dispensing pump having an outlet fluidly coupled to the wash chamber;
multiple wash aid reservoirs; and
a wash aid coupler selectively fluidly coupling the wash aid reservoirs to the dispensing pump.

2. The appliance of claim 1, wherein the wash aid coupler comprises a valve assembly fluidly coupling the wash aid reservoirs to the dispensing pump.

3. The appliance of claim 2, wherein the valve assembly comprises a valve for each of the wash aid reservoirs.

4. The appliance of claim 2, wherein the valve assembly comprises multiple conduits, with at least one of the conduits extending from each of the wash aid reservoirs to the pump.

5. The appliance of claim 4, wherein the valve assembly further comprises a conduit closer to control the flow of wash aid through at least one of the conduits.

6. The appliance of claim 5, wherein the conduit closer comprises a conduit deformer that physically deforms the at least one of the conduits to control the flow of wash aid there through.

7. The appliance of claim 6, wherein the conduit deformer comprises a movable element that may incrementally deform the conduit as the element is moved.

8. The appliance of claim 7, wherein the movable element is positioned between at least two of the conduits wherein movement of the element in a first direction selectively deforms one of the at least two conduits and movement of the element in a second direction, opposite the first direction, selectively deforms the other one of the at least two conduits.

9. The appliance of claim 1, wherein the wash aid reservoirs are replaceable.

10. The appliance of claim 1, wherein the appliance is one of a household clothes washer and dishwasher.
